(19) United States
(12) Patent Application Publication
(10) Pub. No.: US 2010/0274966 A1
(43) Pub. Date: Oct. 28, 2010

(54) HIGH AVAILABILTY LARGE SCALE IT SYSTEMS WITH SELF RECOVERY FUNCTIONS

(75) Inventors: Tomohiro Kawaguchi, Cupertino, CA (US); Hidehisa Shitomi, Yokohama (JP)

Correspondence Address: Hitachi America, Ltd. Intellectual Property Group, 1000 Marina Blvd., 5th Floor, Brisbane, CA, 94005, US

(73) Assignee: Hitachi, Ltd., Tokyo (JP)

(21) Appl. No.: 12/429,503

(22) Filed: Apr. 24, 2009

(51) Int. Cl. G06F 11/07; G06F 12/00

(52) U.S. Cl. 711/114; 714/57; 711/154; 711/E12.001; 714/E11.025

(57) ABSTRACT

Storage Systems in the IT system provide information of the status of its components to the System Monitoring Server. System Monitoring Server calculates storage availability of storage systems based on information using failure rates of the components, and determines whether the volumes of the storage system should be migrated based on a predetermined policy. If migration is required, System Monitoring Server selects the target storage system based on storage availability of storage systems, and requests migration to be performed.

The present invention relates generally to management of IT systems including storage systems, more particularly to methods and apparatus for relocating data or path rerouting.

Storage systems with high availability is required so that even if some parts of the system fails, the storage system blocks the part and offload its control to the order parts. In addition, systems may maintain redundancy so that it could still recover when the system fails.

In recent years IT systems have grown scalability, data centers will be including many servers, switches, cables, and storage systems. It will be more difficult for the IT administrators to manage and operate the systems in large scalability IT systems. In addition, the possibility of component failures increases since the system has more number of components.

U.S. Pat. No. 7,263,590 discloses methods and apparatus for migrating logical objects automatically. U.S. Pat. No. 6,766,430 discloses a host collecting usage information from a plurality of storage systems, and determining relocation destination LU for data stored in the LU requiring relocation. U.S. Pat. No. 7,360,051 discloses volume relocation within the storage apparatus and the external storage apparatus. The relocation is determined by comparing the monitor information of each logical device and the threshold.

### BRIEF SUMMARY OF THE INVENTION

Embodiments of the invention provide methods and apparatus for large scale IT systems. Storage Systems in the IT system provide information of the status of its components to the System Monitoring Server. System Monitoring Server calculates storage availability of storage systems based on information using availability rates of the components, and determines whether the volumes of the storage system should be migrated based on a predetermined policy. If migration is required, System Monitoring Server selects the target storage system based on storage availability of storage systems, and requests migration to be performed.

Another aspect of the invention is directed to a method for managing large scale IT systems including storage systems controlled by a plurality of storage servers. Each storage server reports server uptime to System Monitoring Server, so that System Monitoring Server can determine whether path change is required or not.

These and other features and advantages of the present invention will become apparent to those of ordinary skill in the art in view of the following detailed description of the specific embodiments.

### BRIEF DESCRIPTION OF THE DRAWINGS

FIG. 1 illustrates a hardware configuration of an IT system in which the method and apparatus of the invention may be applied.

FIG. 2 illustrates an example of a storage subsystem of FIG. 1.

FIG. 3 illustrates an example of a memory in the storage subsystem of FIG. 2.

FIG. 4 illustrates an example of a Volume Management Table in the memory of FIG. 3.

FIG. 5 illustrates an example of a Parts Management Table in the memory of FIG. 3.

FIG. 6 illustrates an example of a write I/O control sequence of the storage subsystem of FIG. 1.

FIG. 7 illustrates an example of a read I/O control sequence of the storage subsystem of FIG. 1.

FIG. 8 illustrates an example of a staging control sequence of the storage subsystem of FIG. 1.

FIG. 9 illustrates an example of a destaging control sequence of the storage subsystem of FIG. 1.

FIG. 10 illustrates an example of a flush control sequence of the storage subsystem of FIG. 1.

FIG. 11 illustrates an example of a health check sequence of the storage subsystem of FIG. 1.

FIG. 12 illustrates an example of a failure reporting control sequence of the storage subsystem of FIG. 1.

FIG. 13 illustrates an example of an external volume mount control sequence of the storage subsystem of FIG. 1.

FIG. 14 illustrates an example of a hardware configuration of a host computer of FIG. 2.

FIG. 15 illustrates an example of a memory of FIG. 14.

FIG. 16 illustrates an example of a storage management table of FIG. 15.

FIG. 17 illustrates an example of a configuration control sequence of FIG. 15.

FIG. 18 illustrates an example of a system monitoring server of FIG. 2.

FIG. 19 illustrates an example of a memory of FIG. 18.

FIG. 20 illustrates an example of a storage availability management table of FIG. 19.

FIG. 21 illustrates an example of a volume management table of FIG. 19.

FIG. 22A-C illustrates an example of a storage availability check control sequence stored in memory of FIG. 19.

FIG. 23 illustrates an example of an external volume mount control in memory of FIG. 19.

FIG. 24 illustrates an example of a process flow of IT system of FIG. 1.

FIG. 25 illustrates a hardware configuration of an IT system in which the method and apparatus of the invention may be applied.

FIG. 26 illustrates an example of a memory in the storage server of FIG. 25.

FIG. 27 illustrates an example of a Volume Management Table in the memory of FIG. 26.

FIG. 28 illustrates an example of a Storage Server Management Table in memory of Host Computer of FIG. 25.

FIG. 29 illustrates an example of a memory in the System Monitoring Server of FIG. 25.

FIG. 30 illustrates an example of a Storage Server Management Table in memory of FIG. 29.

FIG. 31 illustrates an example of a Path Management Table in memory of FIG. 29.

FIG. 32 illustrates an example of a Storage Server Check Control in memory of FIG. 29.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment”, “this embodiment”, or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing”, “computing”, “calculating”, “determining”, “displaying”, or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Exemplary embodiments of the invention, as will be described in greater detail below, provide apparatuses, methods and computer programs for fast data recovery from storage device failure.

### First Embodiment

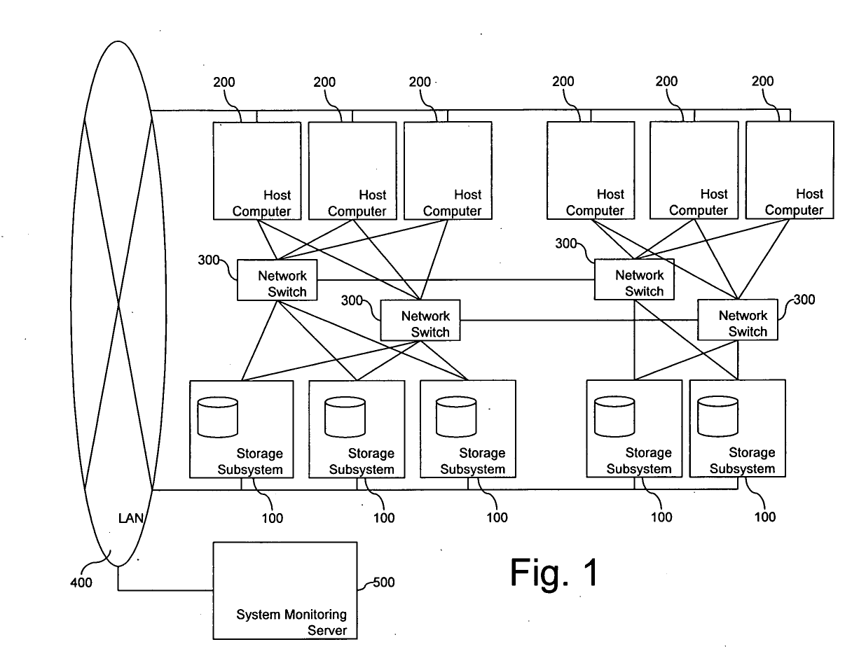

FIG. 1 illustrates the hardware configuration of a system in which the method and apparatus of the invention may be applied. Storage subsystems 100 are connected via a SAN (storage area network) through network switches 300 to a host computer 300. The system monitoring server 500 is connected to the host computers 200 and storage subsystems 100 via LAN (local area network) 400.

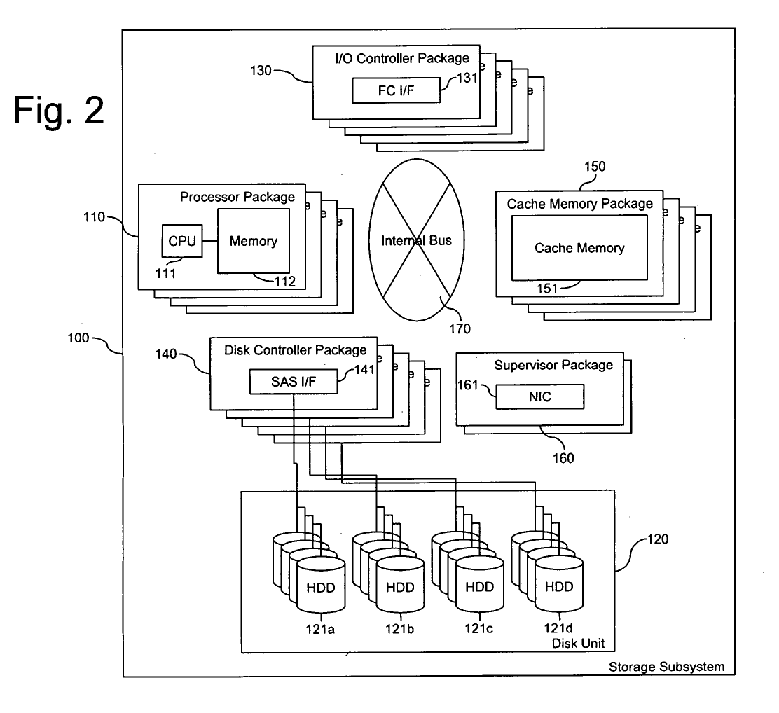

FIG. 2 illustrates the hardware configuration of a storage subsystem 100 of FIG. 1. The storage subsystem 100 includes I/O Controller Packages 130, Cache Memory Packages 150, Processor Packages 110, Disk Controller Packages 140, Supervisor Packages 160 connected via an internal bus 170. Cache Memory Package 150 includes cache memory 151, which stores data received from the Host Computer 200 to be written to the Disks 121 and stores information to control the cache memory 151 itself. Disk Controller Package 110 includes SAS interface (Serial Attached SCSI) and controls a plurality of disks 121. It transfers data between the cache memory 151 and the disks 121, and calculates data to generate parity data or recovery data. The disk unit 120 provides nonvolatile disks 121 for storing data. It could be HDDs (hard disk drives) or Solid State Disks. Processor Package 110 includes a CPU 111 that controls the storage subsystem 100, runs the programs, and uses the tables stored in a memory 112. The memory 112 stores data in addition to programs and tables. I/O Controller Package 130 includes FC I/F (fibre channel interface) provided for interfacing with the SAN. Supervisor Package 160 includes network interface NIC 161 and transfers storage subsystem reports and operation requirement between the Host Computer 200 and CPUs 111.

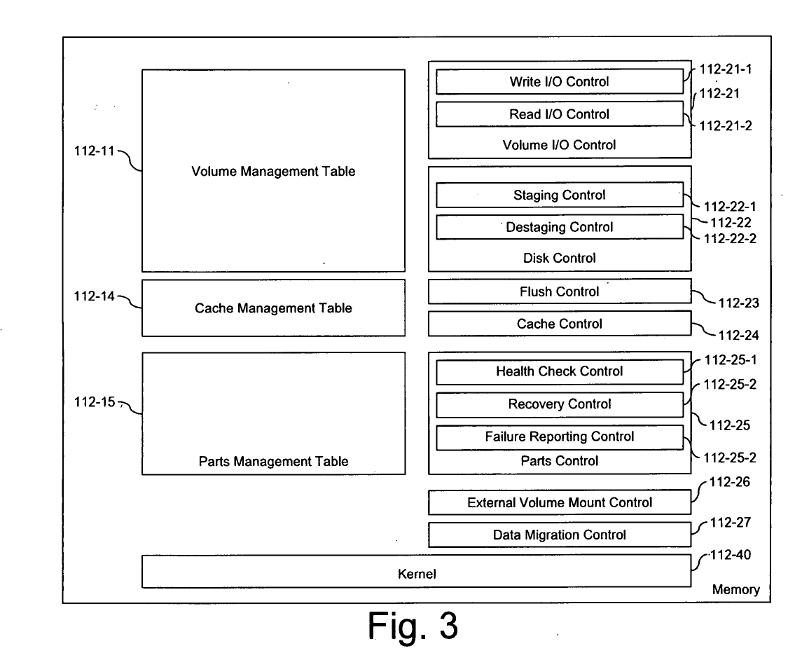

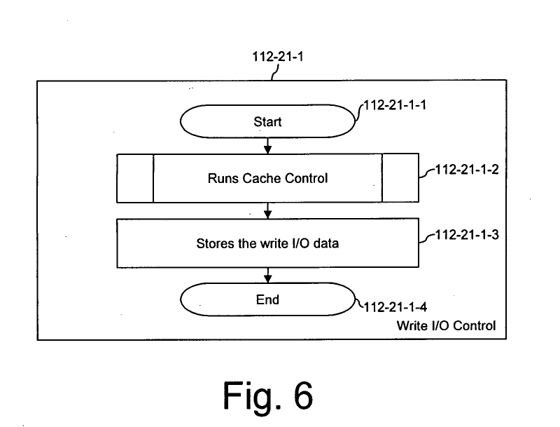

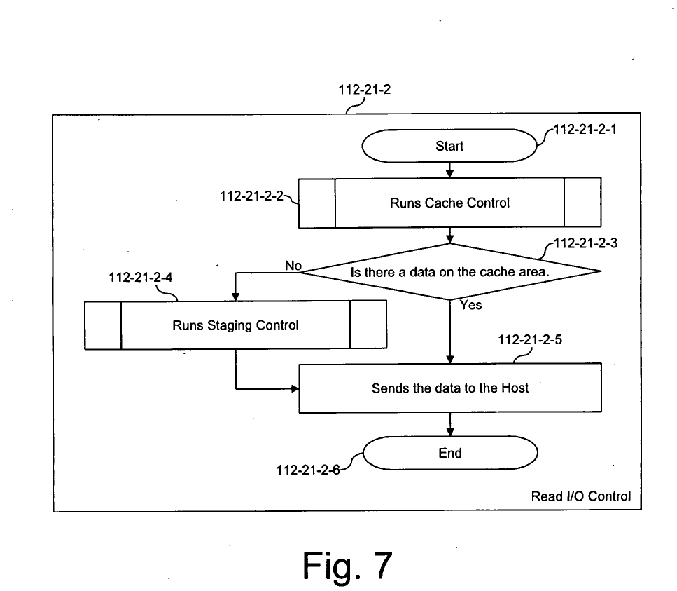

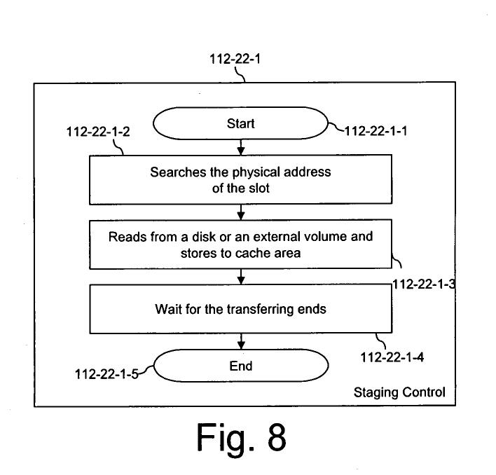

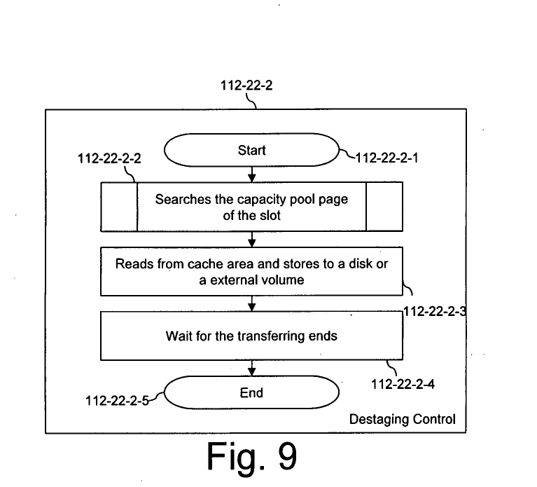

FIG. 3 illustrates an example of a memory 112 in the storage subsystem 100 of FIG. 1. The memory 112 includes a Volume Management Table 112-11 that is used for physical structure management of Disks 121 or external volume and logical volume configuration. A Cache Management Table 112-14 is provided for managing the cache data area 112 and for LRU/MRU management. The Cache Management Table 112-14 includes copy of the information stored in the cache memory 151 to control the cache memory 151. A Volume I/O Control 112-21 includes a Write I/O Control 112-21-1 (FIG. 6) that runs by a write I/O requirement and receives write data and stores to the cache data area 112, and a Read I/O Control 112-21-2 (FIG. 7) that runs by a read I/O requirement and sends read data from the cache data area 112. A Disk Control 112-22 includes a Staging Control 112-22-1 (FIG. 8) that transfers data from the disks 121 to the cache data area 112, a Destaging Control 112-22-2 (FIG. 9) that transfers data from the cache data area 112 to the disks 121.

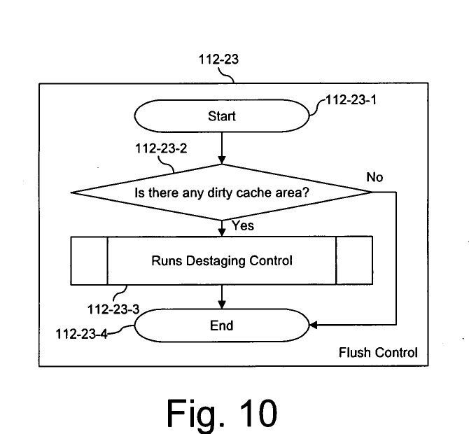

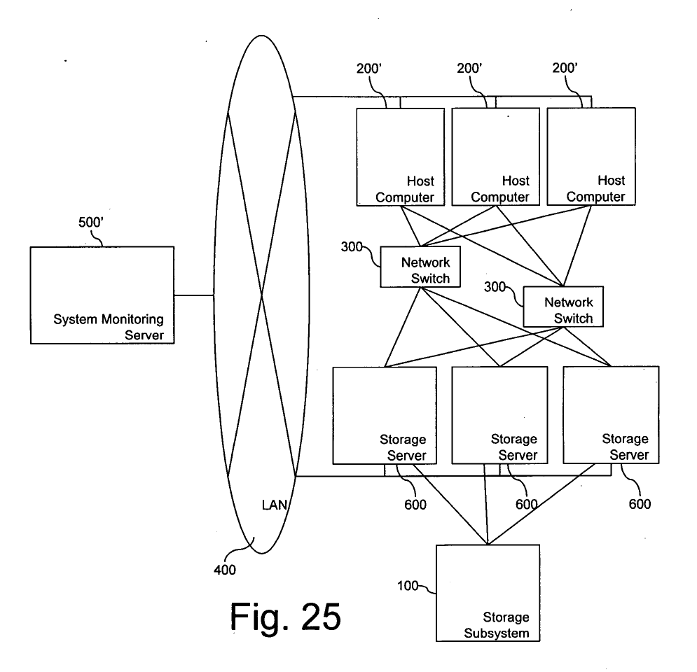

The memory 112 further includes a Flush Control 112-23 (FIG. 10) that periodically flushes dirty data from the cache data area to the disks 121, and a Cache Control 112-24 (FIG. 25) that finds cached data in the cache data area and allocates a new cache area in the cache data area. The memory 112 includes a kernel 112-40 that controls the schedules of running program, supports a multi-task environment. If a program waits for an ack (acknowledgement), the CPU 111 changes to run another task (e.g., data transfer waiting from the disk 121 to the cache data area 112-30).

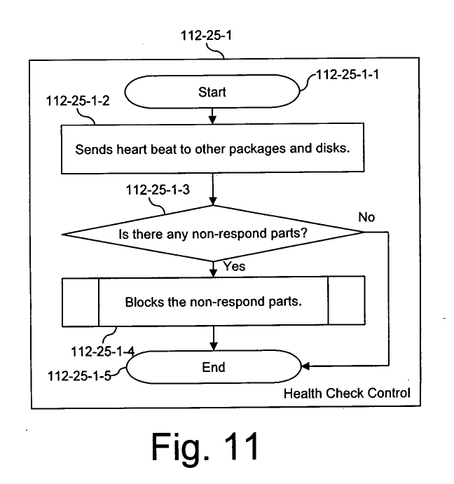

The memory 112 includes Parts Control 112-25 that manages health of Processor Packages 110, I/O Controller Packages 130, Disk Controller Packages 140, Cache Memory Packages 150, Supervisor Packages 160 and disks 121. Parts Control 112-25 includes Health Check Control 112-25-1 (FIG. 11) that sends heart beat to other parts, Recovery Control 112-25-2 that blocks the package and manages recovery when some part failure occurs, and Failure Reporting Control 112-25-3 that reports to System Monitoring Server 500 via Network Interface 161 and Network 400 periodically or when failure occurs.

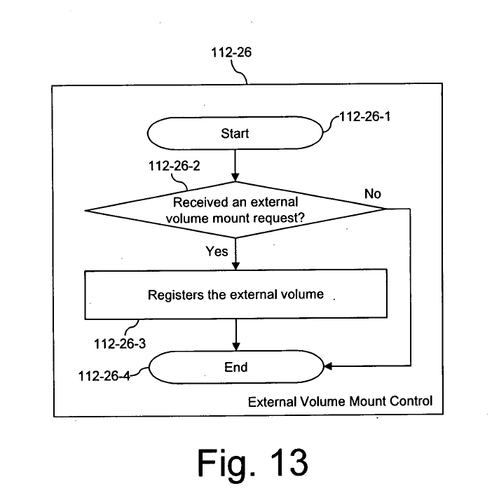

The memory 112 includes External Volume Mount Control 112-26 (FIG. 13) that controls mounting of external volumes mounting. The memory 112 includes Data Migration Control 112-27 that controls data migration between the volumes.

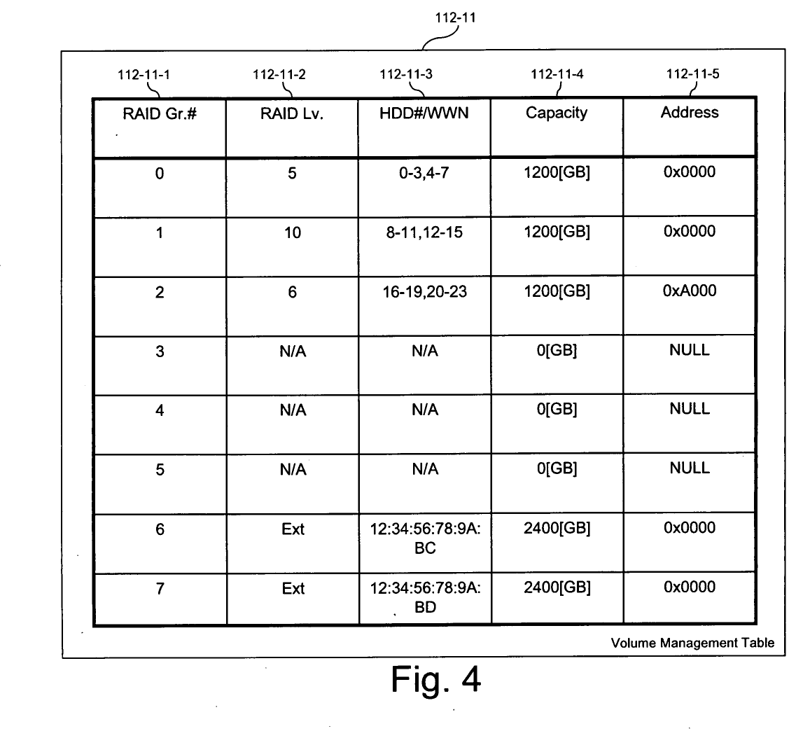

FIG. 4 illustrates an example of a Volume Management Table 112-11 in the memory 112 of FIG. 2. The Volume Management Table 112-11 includes columns of the RAID Group Number 112-11 -1 as the ID of the RAID group, and RAID Level 112-11-2 representing the structure of RAID group. For example, “5” means “RAID Level is 5”. “N/A” means the RAID Group does not exist. “Ext” means the RAID Group is exist as an external volume outside of the internal volume. The RAID Group Management Table 112-11 includes columns 112-11-3 of the HDD Number representing the ID list of HDDs belong to the RAID group in case if it is an internal volume or WWN in case if it is an external volume. The RAID Group Management Table 112-11 further includes RAID Group Capacity 112-11-4 representing the total capacity of the RAID group except redundant area, and Address information 112-11-5 of the logical volume in the RAID Group. In this example the top address of the logical volume is show.

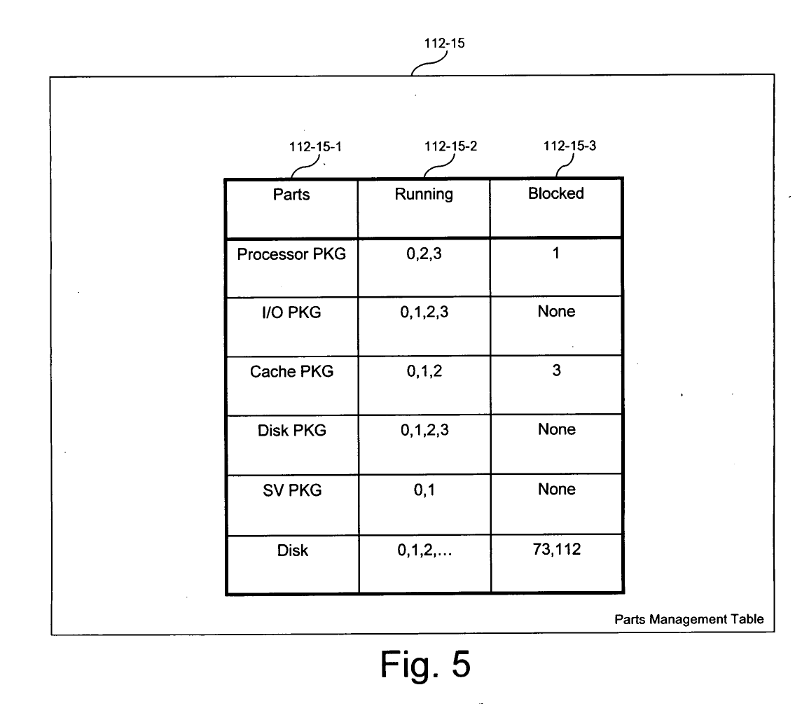

FIG. 5 illustrates an example of a Parts Management Table 112-15 in the memory 112 of FIG. 2. The Parts Management Table 112-15 includes columns of the Parts Type 112-15-1 indicating package or media type information. The Parts Management Table 112-15 includes columns of the Running Parts List 112-15-2, which lists IDs of the running parts and the Blocked Parts List 112-15-3, which lists IDs of the blocked parts. For example, Running Parts List 112-15-2 of “0,2,3” and Blocked Parts List 112-15-3 of “1” for Processor Package means that Package ID 0,2,3 are running and that Package ID 1 is blocked for the Processor Packages. Blocked Parts List 112-15-3 of “None” means that the packages are all operating.

FIG. 6 illustrates an example of a process flow of the Write I/O Control 112-21-1 in the memory 112 of FIG. 2. The program starts at 112-21-1-1. In step 112-21-1-2, the program calls the Cache Control 112-24 to search the cache slot 112-30-1. In step 112-21-1-3, the program receives the write I/O data from the host computer 300 and stores the data to the aforementioned cache slot 112-30-1. The program ends at 112-21-1-4.

FIG. 7 illustrates an example of a process flow of the Read I/O Control 112-21-2 in the memory 112 of FIG. 2. The program starts at 112-21-2-1. In step 112-21-2-2, the program calls the Cache Control 112-24 to search the cache slot 112-30-1. In step 112-21-2-3, the program checks the status of the aforementioned cache slot 112-30-1 to determine whether the data has already been stored there or not. If the data is not stored in the cache slot 112-30-1, the program calls the Staging Control 112-22-1 in step 112-21-2-4. In step 112-21-2-5, the program transfers the data in the cache slot 112-30-1 to the host computer 300. The program ends at 112-21-2-6.

FIG. 8 illustrates an example of a process flow of the Staging Control 112-22-1 in the memory 112 of FIG. 2. The program starts at 112-22-1-1. In step 112-22-1-2, the program calls the Physical Disk Address Control 112-22-5 to find the physical disk and address of the data. In step 112-22-1-3, the program requests the data transfer controller 116 to read data from the disk 121 and store it to the cache data area 112-30. In step 112-22-1-4, the program waits for the data transfer to end. The kernel 112-40 in the memory 112 will issue an order to do context switch. The program ends at 112-22-1-5.

FIG. 9 illustrates an example of a process flow of the Destaging Control 112-22-2 in the memory 112 of FIG. 2. The program starts at 112-22-2-1. In step 112-22-2-2, the program calls the Physical Disk Address Control 112-22-5 to find the physical disk and address of the data. In step 112-22-2-3, the program requests the data transfer controller 116 to read data from the cache data area 112-30 and store it to the disk 121. In step 112-22-2-4, the program waits for the data transfer to end. The kernel 112-40 in the memory 112 will issue an order to do context switch. The program ends at 112-22-2-5.

FIG. 10 illustrates an example of a process flow of the Flush Control 112-23 in the memory 112 of FIG. 2. The program starts at 112-23-1. In step 112-23-2, the program reads the “Dirty Queue” of the Cache Management Table 112-14. If dirty cache area is found, the program calls the Destaging Control 112-22-2 for the found dirty cache slot 112-30-1 in step 112-23-3. The program ends at 112-23-4.

FIG. 11 illustrates an example of a process flow of the Health Check Control 112-25-1 in the memory 112 of FIG. 2. The program starts at 112-25-1-1. In step 112-25-1-2, the program makes the CPU send heart beat to other running parts. In step 112-25-1-3, the program checks if it has received the acknowledgments of the heart beat or not. If there are no non-respond parts, the program finishes the Health Check Control program by moving to step 112-25-1-5. If there is a non-respond part, the program blocks the corresponding part as in step 112-25-1-4. The program by calling Recovery Control 112-25-2 blocks the failure part. The program ends at 112-23-4.

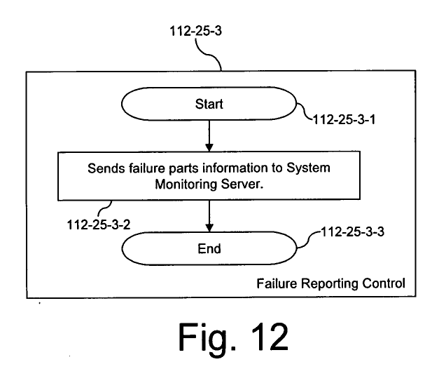

FIG. 12 illustrates an example of a process flow of the Failure Reporting Control 112-25-3 in the memory 112 of FIG. 2. The program starts at 112-25-3-1. In step 112-25-3-2, the program sends information of failure parts to System Monitoring Server 500 via Network Interface 161 and Network 400. This can be performed by transferring the Parts Management Table 112-15 to System Monitoring Server 500. The program ends at 112-25-3-3.

FIG. 13 illustrates an example of a process flow of the External Volume Mount Control 112-26 in the memory 112 of FIG. 2. The program starts at 112-26-1. In step 112-26-2, the program checks if it has received an external volume mount request or not. If it had received an external volume mount request, the program moves to step 112-26-3. In step 112-26-3, the program registers the external volume information to Volume Management Table 112-11-1 and moves to step 112-26-4. If it had not received an external volume mount request, the program finishes by moving to step 112-26-4. The program ends at 112-26-4.

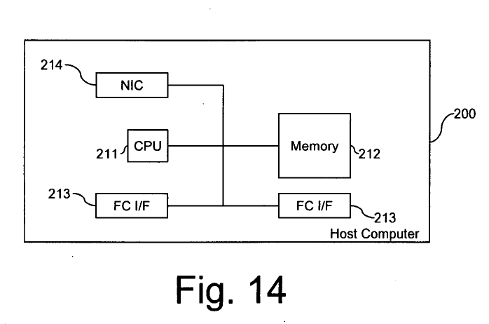

FIG. 14 illustrates the hardware configuration of a Host Computer 200 of FIG. 1. The Host Computer 200 includes a Memory 212, a CPU 211, a network interface NIC 214, and a plurality of FC I/F 213 provided for interfacing with the SAN. The Memory 212 stores programs and tables for CPU 211. FC I/F 213 allows the CPU to send I/Os to the storage subsystems 100. The network interface NIC 214 receives configuration change requirement from system monitoring server 500.

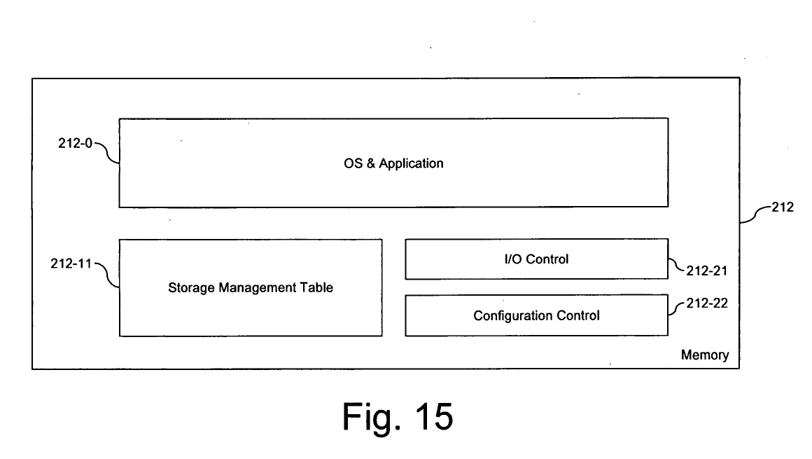

FIG. 15 illustrates an example of a memory 212 in the host computer 200 of FIG. 1. The memory 212 includes an Operating System and Application 212-0, a Storage Management Table 212-11, I/O Control 212-21, and Configuration Control 212-22. The applications provided includes programs and libraries to control the server process. Storage Management Table 212-11 stores volumes and path information, which the Host Computer 200 uses. An I/O Control 212-21 includes read and write I/O control program managed by Storage Management Table 212-11. A Configuration Control 212-22 manages the configuration of the Host Computer 200 and changes the configuration of volume and path of the Host Computer 200 in response to a change requirement received from System Monitor Server 500 via Network Interface 214.

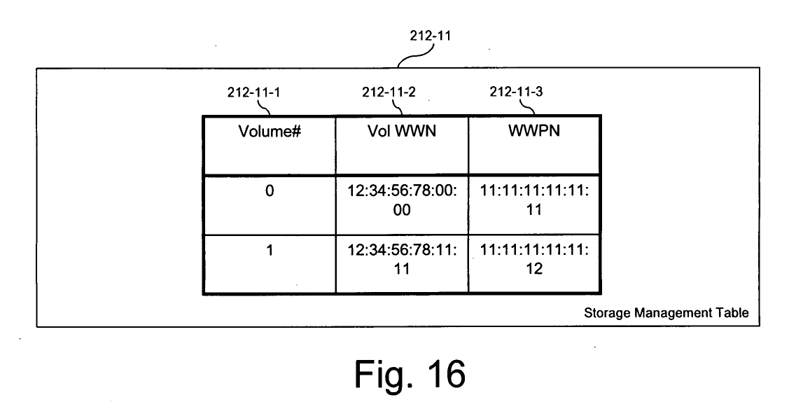

FIG. 16 illustrates an example of a Storage Management Table 212-11 in the memory 212 of FIG. 14. The Storage Management Table 212-11 includes columns of the Volume Number 212-11-1 as the index of the volume used by the host computer, and Volume WWN representing the ID of volume in the system, WWPN 212-11-3 representing the ID of connected port of Network Switch 300.

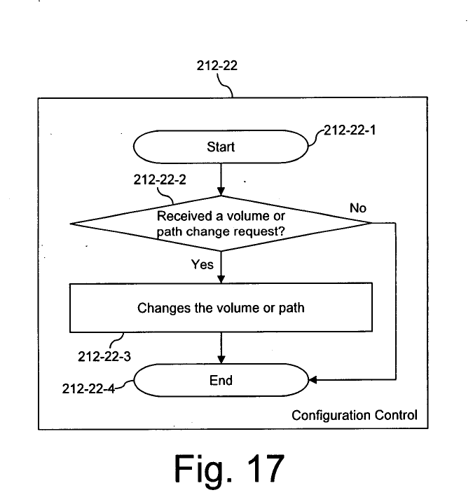

FIG. 17 illustrates an example of a process flow of the Configuration Control 212-22 in the memory 212 of FIG. 14. The program starts at 212-22-1. In step 212-22-2, the program checks if the CPU 211 received a volume request or path change the Storage Management Table 212-11 according to the request from the system monitoring server 500. If the request was received, the program changes the volume or path according to the request from the system monitoring server 500 in step 212-22-3. If the request was not received, the program moves to step 212-22-4. The program ends at step 212-22-4.

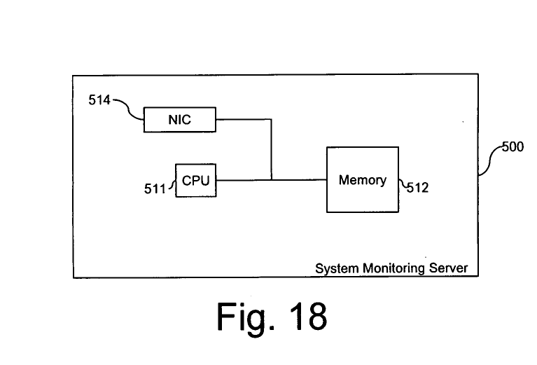

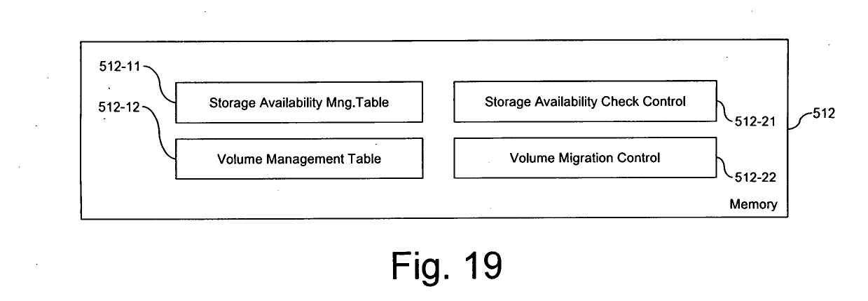

FIG. 18 illustrates the hardware configuration of a System Monitoring Server 500 of FIG. 1. The System Monitoring Server 500 includes a Memory 512, a CPU 511 controlling the Host Computers 200, and a network interface NIC 514. The Memory 512 stores programs and tables for CPU 511. The network interface NIC 214 receives availability information from Storage Subsystems 100 and sends configuration change requirement to Host Computers 200 and Storage Subsystems 100.

FIG. 19 illustrates an example of a memory 512 in the System Monitoring Server 500 of FIG. 18. The memory 512 includes a Storage Availability Management Table 512-11, a Volume Management Table 512-12, a Storage Availability Check Control 512-21, and a Volume Migration Control 512-22. The Storage Availability Management Table 512-11 stores storage availability information received from Storage Subsystems 100. The Volume Management Table 512-12 stores volume information, such as ID, path, storage, zoning of host computers and networks. The Storage Availability Check Control 512-21 is a program that calculates the storage availability using the Storage Availability Management Table 512-11, and finds low available storage subsystems that are subjected to migration. The Volume Migration Control 512-22 is a program that changes I/O path, migrates a volume from one of the Storage Subsystems 100 to an another Storage Subsystem 100 using the Volume Management Table 512-12.

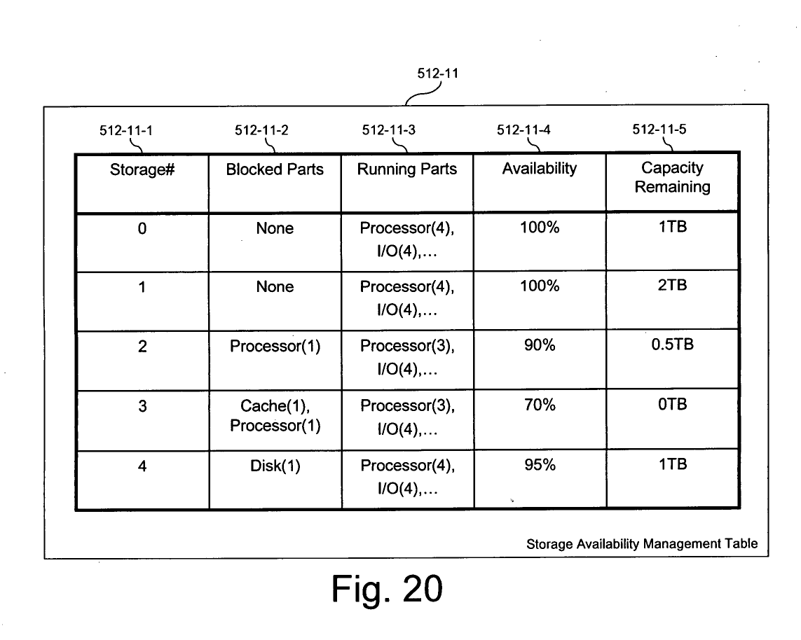

FIG. 20 illustrates an example of a Storage Availability Management Table 512-11 in the memory 512 of FIG. 19. The Storage Availability Management Table 512-11 includes columns of the Storage Number 512-11-1 indicating ID of the Storage Subsystem 100. The Storage Availability Management Table 512-11 includes columns of the Blocked Parts 512-11-2, which lists IDs of blocked packages and disks, and the Running Parts 512-11-3, which lists IDs of the running packages and disks. For example, Blocked Parts 512-11-2 of “None” and Running Parts 512-11-3 of “Processor(4), I/O(4), . . . ” for Storage Number “0” means that all four Processor PKGs and all four I/O PKGs are running, and that no Package are blocked and the packages are all operating. Blocked Parts 512-11-2 of “Processor(1)” and Running Parts 512-11-3 of “Processor(3), I/O(4), . . . ” for Storage Number “2”, means that three Processor PKGs and all four I/O PKGs are running, and that one Processor PKG is blocked. The Storage Availability Management Table 512-11 includes columns of the Availability 512-11-4, which is calculated from the number and type of blocked parts and running parts, and Capacity Remaining 512-11-5, which represents the unused, usable capacity of the Storage Subsystem 100.

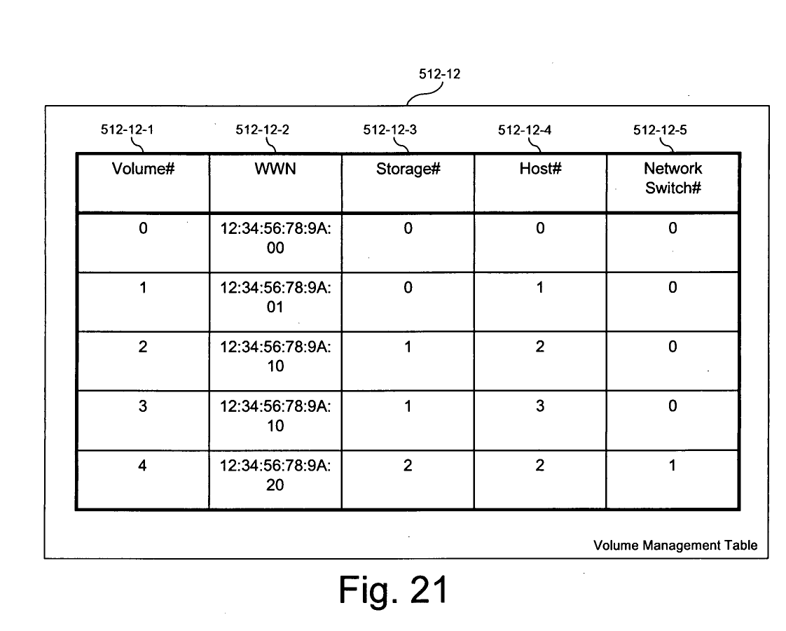

FIG. 21 illustrates an example of a Volume Management Table 512-12 in the memory 512 of FIG. 19. The Volume Management Table 512-12 includes columns of the Volume Number 512-12-1 as the index of the volume used by the host computer, World Wide Name WWN 512-12-2, Storage Number 512-12-3 representing the ID of Storage Subsystem including the volume in the system, Host Computer Number 512-12-4 representing the ID of Host Computer 200 used by the volume, and Network Switch Number 512-12-5 representing the ID of Network Switch 300 used for access to the volume. Same ID of Network Switch Number means that the volumes and servers are close.

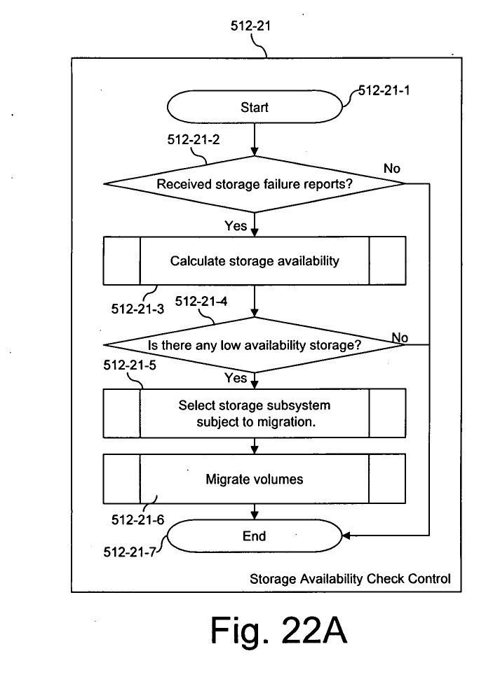

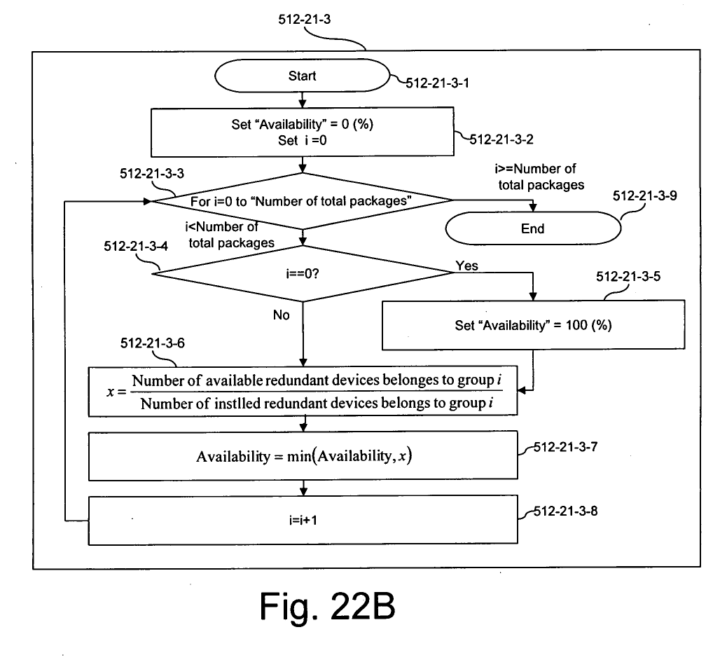

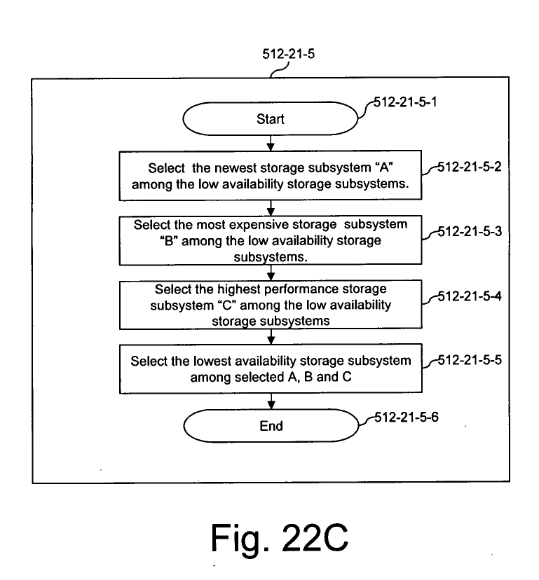

FIG. 22A illustrates an example of a process flow of the Storage Availability Check Control 512-21 in the memory 512 of FIG. 14. The program starts at 512-21-1. In step 512-21-2, the program checks if the CPU 211 received a storage failure information or not. If the request was received, the program calculates storage availability from the number and type of blocked parts and running parts for the storage subsystem, which notified the storage failure and stores the availability and failure information to Storage Availability Management Table 512-11 in step 512-21-3. If the request was not received, the program moves to step 512-21-7. After the storage availability is calculated the program checks if the calculated results are less than the threshold or not in step 512-21-4. If there is any low storage availability storage subsystem that is less than the predetermined value than the program selects which storage subsystem should be migration in step 512-21-5. If there is no storage subsystem having a storage availability under the predetermined threshold, the program moves to step 512-21-7. After the source storage subsystems for migrating is determined in step 512-21-5, the CPU 211 calls Volume Migration Control 512-22 to perform the migration from the selected highest priority storage subsystem in step 512-21-6. In this embodiment not all the storage subsystems that have a storage availability under the predetermined threshold are migrated. This is because even though the storage availability is low, if the tier of storage subsystem is low and does not storing data that has a relatively high importance; it should not be subject to migration. Though migration will be performed off-line it does increase the load of the storage subsystem performing migration, so selection process of which storage subsystem should be conducted. The selection could be based on how important the data stored is, or whether it is a storage subsystem that is relatively highly relied on or not. The program ends at step 512-21-7.

FIG. 22B illustrates an example of a process flow of the step 512-21-3 of the Storage Availability Check Control 512-21 in FIG. 22A. This program calculates the storage availability for storage subsystems. The program starts at step 512-21-3-1. In step 512-21-3-2, the program initializes availability value as zero percent, and counter number “i” as zero. Counter number “i” will be used as a counter to calculate the availability for each package. In step 512-21-3-3 the program will determine if the package needs calculation for availability. If “i” is below the number of total packages, the program would proceed to step 512-21-3-4. If “i” is or more than the number of total packages, the program should end at step 512-21-3-9. In step 512-21-3-4 the program will check if “i” is zero or not. If “i” is zero, the program would proceed to step 512-21-3-5 and set availability value as one hundred percent. This value would be used as an initial comparison value with the actual calculated value of each package. If “i” is not zero, the program would proceed to step 512-21-3-6 and calculate value “x” for package number “i” by dividing the number of available redundant devices belonging to package group “i” by the number of installed redundant devices belonging to package group “i”. Next, the program proceeds to step 512-21-3-7 and compare the availability value with the calculated value “x” and chose the lower value as new availability value. After the new availability value is set, the program proceeds to step 512-21-3-8 and adds “1” to “i”, so that it can calculate the availability of other packages, which have not been considered. Then the program proceeds back to step 512-21-3-3 to calculate the availability of the next package.

Steps 512-21-3-1 to 512-21-3-8 will as a result calculate the lowest availability package value, which should be the controlling package for performance of the storage subsystem. For example, in case of the storage subsystem of RAID 6 level with each stripe of 6 Data and 2 Parities, it will require at least four disks containing data to keep the data. If there is one broken disk, the calculated Disk package “x” would be 50(%) since it had two installed redundant disks and now has one available redundant disk. The storage subsystem includes 100 DRAMs used for Cache Memories and each cache memory will require at least one DRAM to keep the data. If there are 13 broken DRAMs, the calculated Cache Memory Package “x” would be 86.9(%) since it had 99 installed redundant disks and now has 86 available redundant disk. If the other packages such as Disk Controller Package, I/O Controller Packages have no broken components, the storage systems availability would be 50(%) since it would have the lowest value.

FIG. 22C illustrates an example of a process flow of the step 512-21-5 of the Storage Availability Check Control 512-21 in FIG. 22A. This program determines the storage subsystem that is subject to migration. In this example, System Monitoring Server 500 would be selecting storage system subjected to migration using factors of used years, expected performance, and quality. Though availability value of the storage subsystem would reflect whether the storage subsystem has components that have relatively low weak reliability, whether the data of that storage subsystem should be migrated to a relatively high reliability storage subsystem would rely on the importance of the data stored and how much that storage subsystem is relied upon. Since migration does affect the load of system, migration should be balanced with how important the migration of the data is and how much load does it cause. In this example, how old, how expensive, and how much performance is expected would be used as factors to deciding the storage subsystem which is subject to migration. This is effective because important information would be stored to relatively new storage subsystems rather than old; or to relatively expensive storage subsystems, such as storage subsystems using SATA disks, rather than unexpensive storage subsystems, such as storage subsystems using SCSI disks or tapes; or to relatively high performance storage subsystems rather than low ones. The information for these factors would be stored in memory 512.

The program starts at step 512-21-5-1. In step 512-21-5-2, the program selects the newest storage subsystem among the storage subsystems having availability value lower than threshold. Next in step 512-21-3-3 the program selects the most expensive storage subsystem among the storage subsystems having availability value lower than threshold. Then in step 512-21-3-4 the program selects the highest performance storage subsystem having availability value lower than threshold. Storage subsystems having large number of processors or memory inside the processor package generally have high performance level. Finally, in step 512-21-5-5 the program determines the storage subsystem haven the lowest availability value among the selected storage subsystems in steps 512-21-3-2 to 512-21-3-4 as a migration source storage subsystem. The program ends at step 512-21-6. If the number of storage failure reports are few, this program would not be effective because the selected storage subsystems would be same in steps 512-21-3-2 to 512-21-3-4, but it would be effective when the system scale is large and certain amount of time has passed from the initial operation. Number of failure reported storage subsystems should grow and even though a storage subsystem has the lowest availability value, it would not be selected in any of the steps 512-21-3-2 to 512-21-3-4 and thus not be the source storage subsystem for migration. This would be situation as the storage subsystem is old compared to other storage subsystems and is not a high performance storage subsystem. In this example, System Monitoring Server 500 automatically determines if migration should be conducted under predetermined policies, but System Monitoring Server 500 could also display information on failure reports from storage subsystems, storage subsystems requiring migration, and allow the user make the final decision.

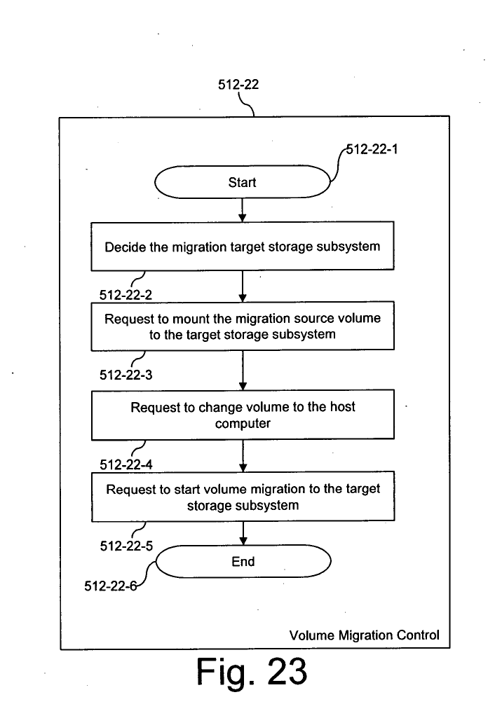

FIG. 23 illustrates an example of a process flow of Volume Migration Control 512-22 in FIG. 19. This program performs the migration process. The program starts at 512-22-1. In step 512-22-2, the program selects migration target storage subsystem 100 using Storage Availability Management Table 512-11 and Volume Management Table 512-12. The target storage subsystem would be selected by comparing factors such as Availability 512-11-4, Capacity Remaining 512-11-5, Network Switch Number 512-12-5. Storage subsystems having relatively high availability, having relatively large quantity of capacity remaining, and having close network location to the source storage subsystem would be selected. In step 512-22-3, the program sends volume mount request to the selected migration target storage subsystem 100 in step 512-22-2. In step 512-22-4, the program sends volume change request to Host Computer 200 using the migration source storage subsystem. In step 512-22-5, the program sends volume migration request to the source migration Storage Subsystem 100, which is subject to migration determined in step 512-21-5 of the Storage Availability Check Control 512-21. The program ends at 512-22-6.

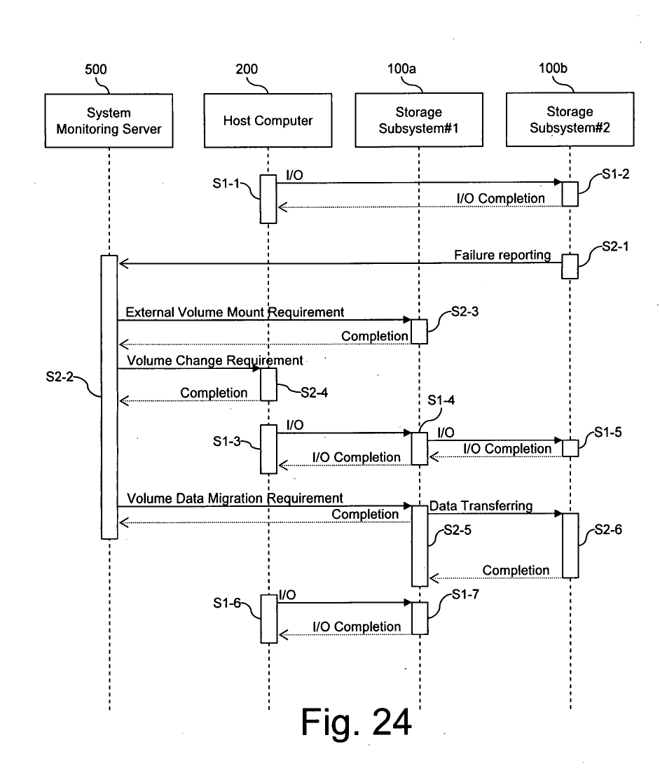

FIG. 24 illustrates an example of the management and operation performed in system of FIG. 1, where Storage Subsystem #2 100b reports failure of a component to the system Monitoring Server 500. How I/O requests from Host Computer 200 would be processed before and after the migration is shown. Host Computer 200 sends I/O request to Storage Subsystem #2 100b (S1-1). Storage Subsystem #2 100b receives I/O request and stores data from or transfers data to Host Computer 200 (S1-2).

In event of a defect of a component in Storage Subsystem #2 100b, Storage Subsystem #2 100b reports failure information to System Monitoring Server 500(S2-1). System Monitoring Server 500 checks availability using Storage Availability Check Control 512-21. In this case, it determines that Storage Subsystem #2 100b has low availability and needs migration to Storage Subsystem #2 100b. System Monitoring Server 500 requests Storage Subsystem #1 100a to mount a volume of Storage Subsystem #2 100b. Storage Subsystem #1 100a returns acknowledgement to System Monitoring Server 500(S2-3). Then, System Monitoring Server 500 requests Host Computer 200 to change accessing volume in Storage Subsystem #2 100b to target volume in Storage Subsystem #1 100a. Host Computer 200 returns acknowledgement to System Monitoring Server 500(S2-4). After the acknowledgment, Host Computer 200 sends I/O requests to Storage Subsystem #1 100a(S1-3). When Storage Subsystem #1 100a receives I/O request from Host Computer 200, it forwards to Storage Subsystem #2 100b if its cache missed (read miss case) (S1-4). Storage Subsystem #2 100b receives I/O request, transfers data to or stores data from Storage Subsystem #1 100a. Storage Subsystem #2 100b sends acknowledgment to Storage Subsystem #1 100a in case if I/O request was a write command (S1-5). Storage Subsystem #1 100a receives data obtained from Storage Subsystem #2 100b and sends to Host Computer 200. Storage Subsystem #1 100a sends acknowledgment to Host Computer 200 in case if I/O request was a write command (S1-4).

After the acknowledgment of Volume Change request from Host Computer 200, and System Monitoring Server 500 sends request to Storage Subsystem #1 100a to mount a volume from Storage Subsystem #2 100b. Storage Subsystem #1 100a sends acknowledgment to System Monitoring Server 500(S2-5). Storage Subsystem #1 100a reads data of the source volume of Storage Subsystem #2 100b and stores data to target volume of Storage Subsystem #1 100a(S2-6).

After the acknowledgment of Volume Migration request from Storage Subsystem #1 100a, Host Computer 200 sends I/O request to Storage Subsystem #1 100a and Storage Subsystem #1 100a will process the I/O request within its own system(S1-7).

### Second Embodiment

FIG. 25 illustrates the hardware configuration of a system in which the method and apparatus of the invention may be applied. The difference with FIG. 1 the first embodiment is that a plurality of Storage Server 400 connected to the Host Computers 200′ and System Monitoring Server 500′ via LAN 400 and Network Switches 300, controls Storage Subsystems 100. Components and functions of Storage Subsystem 100, Network Switch 300, LAN 400 are same as described in first embodiment.

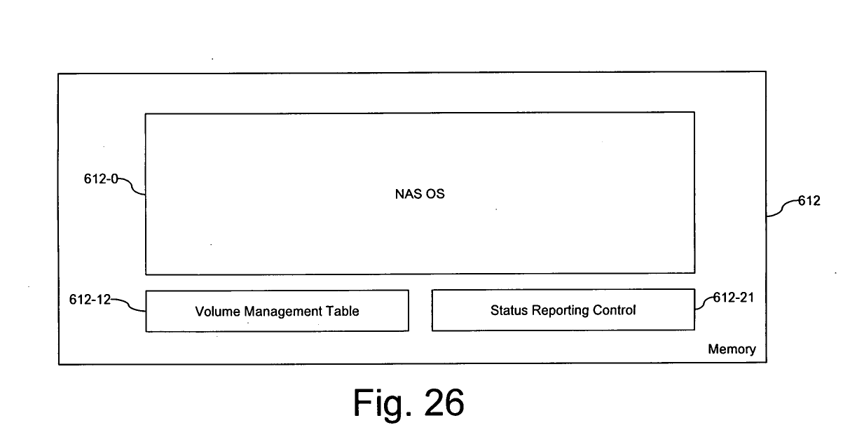

Storage Servers 600 have the same components as HOST Computers in FIG. 14. FIG. 26 illustrates an example of a memory included Storage Server 600. The memory stores a Network Attached Storage Operating System (NAS OS) 612-0, including programs and libraries to control storage server process, Volume Management Table 612-12, storing information of volumes and Host Computer 200′, Status Reporting Control 612-21. Status Reporting Control 612-21, is a program that periodically reports the storage server information to System Monitoring Server 500′. The program sends the server uptime information of the Storage Server 600 to System Monitoring Server 500′. Server uptime information reflects the reliability of the server.

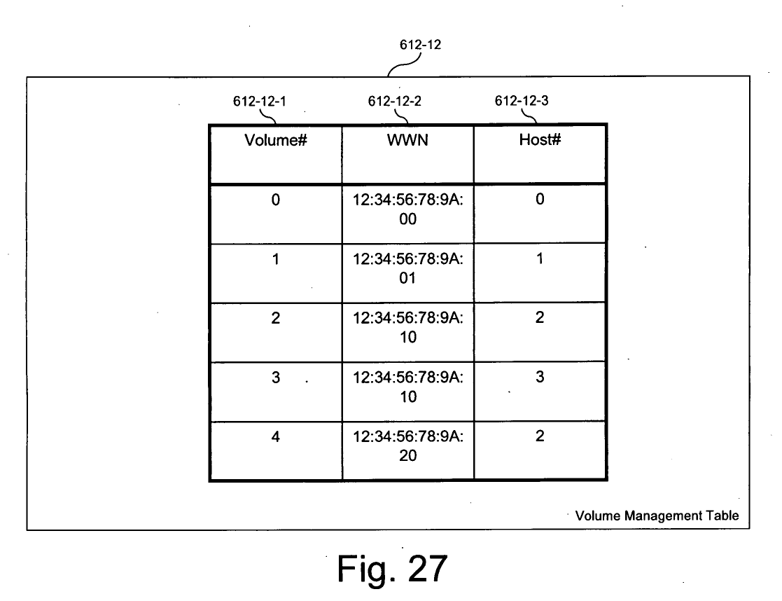

FIG. 27 illustrates an example of a Volume Management Table 612-12 in the memory of the Storage Server 600. The Volume Management Table 612-12 includes columns of the Volume Number 612-12-1 as the index of the volume used by the host computer, and Volume WWN representing the ID of volume in the system, Host Number 612-12-3 representing the ID of Host Computer 200′ using the volume.

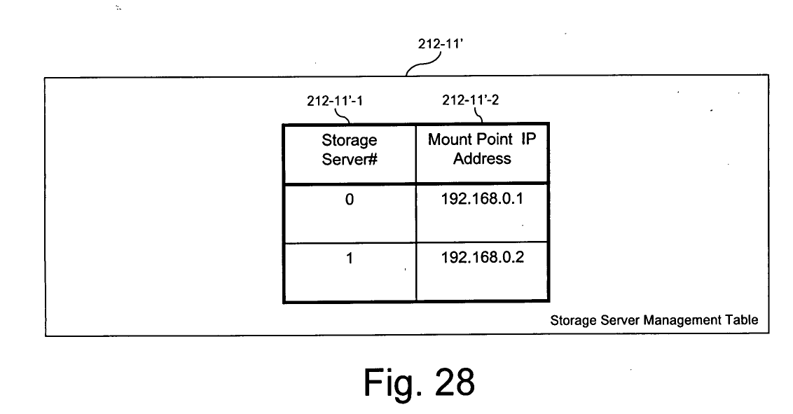

Host Computers 200′ have basically the same configuration as FIG. 14. The difference is that the FC I/F 213 provided for interfacing with the SAN is replaced by network interface NIC provided to interface with the Storage Servers 600. Memory of the Host Computer 200′ includes a Storage Server Management Table 212-11′ as in FIG. 28, instead of Storage Management Table 212-111 in FIG. 15.

FIG. 28 illustrates an example of a Storage Server Management Table 212-11 ′ stored in the memory of the Host Computer 200′. The Storage Server Management′ Table 212-11 includes columns of the Storage Server Number 212-11′-1 as the index of the Storage Server 400 used by the host computer, and Mount Point IP Address 212-11′-2 representing the ID and path information of the Storage Server 400.

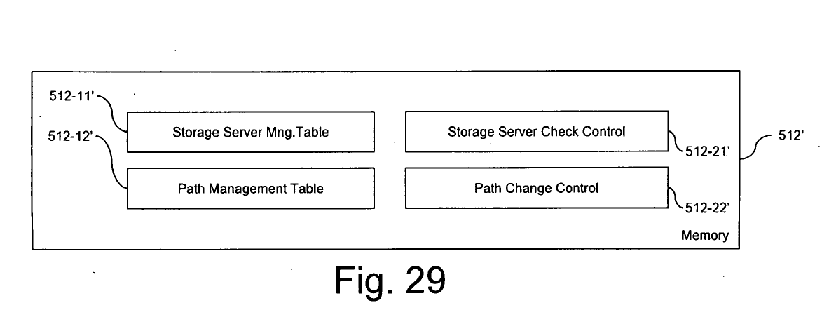

System Monitoring Server 500′ has basically the same configuration as FIG. 18. FIG. 29 illustrates an example of a memory in the System Monitoring Server 500′ of FIG. 25. The memory 512′ includes an Storage Server Management Table 512-11′ including storage server uptime information received from Storage Servers 600, Path Management Table 512-12′ storing the path information of Host Computer 200′ and network, Storage Server Check Control 512-21′ which calculates reliability of Storage Servers 600 and determines which Storage Servers 600 need to be replaced. The memory also includes Path Change Control 512-22′, which changes I/O path between Storage Subsystems 100 and Storage Servers 600, and between Host Computers 200′ and Storage Servers 600.

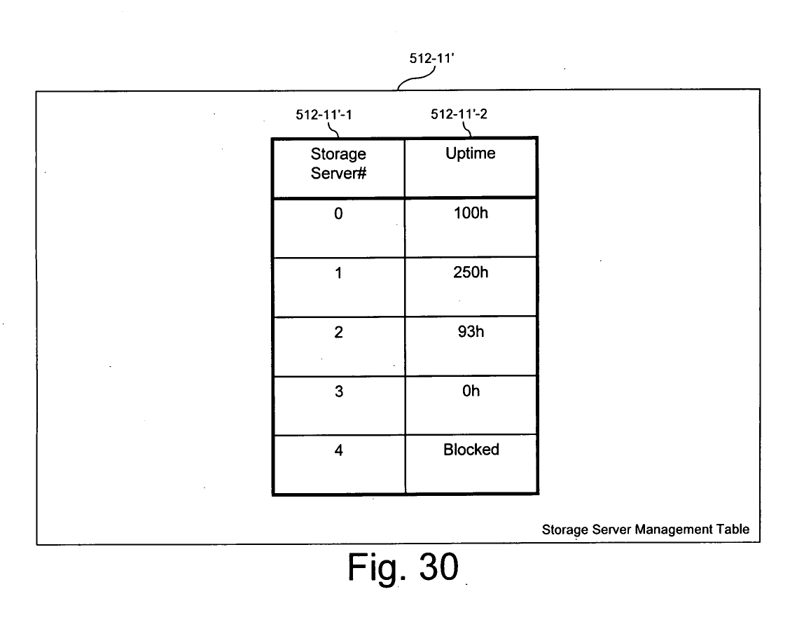

FIG. 30 illustrates an example of a Storage Server Management Table 512-11′ in a memory of Storage Server 600. The Storage Server Management Table 512-11′ includes columns of the Storage Server Number 512-11′-1 as the index of the Storage Server 600 used by the host computer, and Uptime 512-11′-2 representing the uptime information of the Storage Server 600. “Blocked” means the storage server is not used because of a failure or insured time ended.

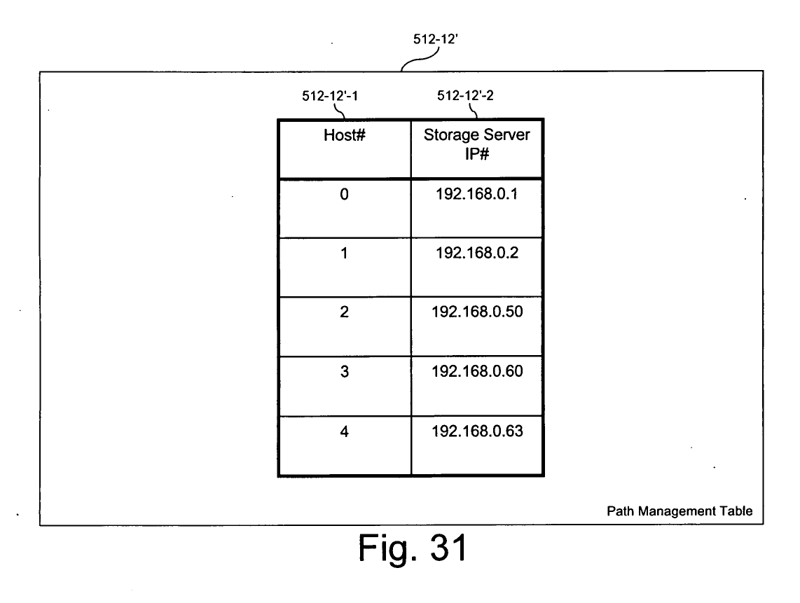

FIG. 31 illustrates an example of a Path Management Table 512-12′ in a memory of Storage Server 600. The Path Management Table 512-12′ includes columns of the Host Number 512-12′-1 as the ID of Host Computer 200′, and Path Information 512-12′2 representing the path address of the Storage Server 600 which Host Computer 200 accesses.

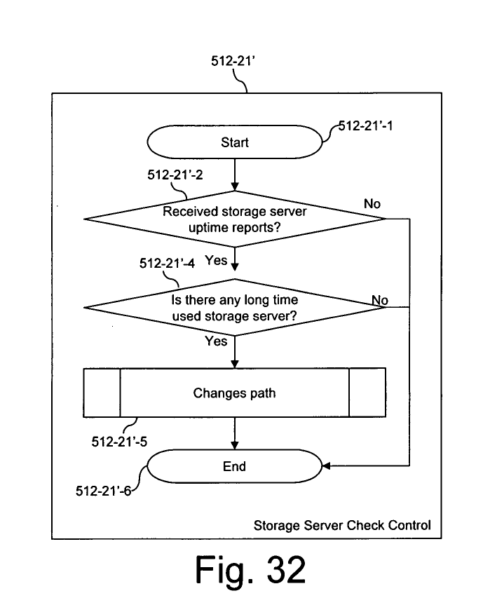

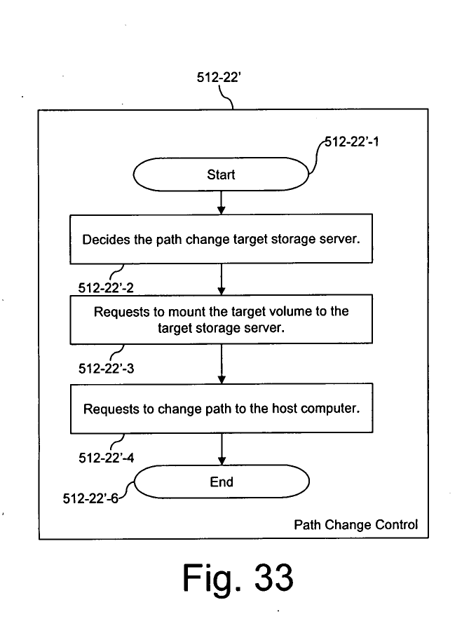

FIG. 32 illustrates an example of a process flow of the Storage Server Check Control 512-21′ in the memory 512′ of FIG. 29. The program starts at 512-21′-1. In step 512-21′-2, the program checks if System Monitoring Server 500′ received report of uptime from Storage Servers 600. If the report was received, the program checks if the uptime reported is above the predetermined threshold or not in step 512-21′-4. Then in step 512-21′-5, the program calls Path Change Control 512-22′ to change the path through the Storage Server 600 for another Storage Server 600 in step 512-21′-5. If the request was not received, the program moves to step 512-21′-6. The program ends at step 512-21′-6.

FIG. 33 illustrates an example of a process flow of the Path Change Control 512-22′ in the memory 512′ of FIG. 29. The program starts at 512-22′-1. In step 512-22′-2, the program select path change target Storage Server 600 using Storage Server Management Table 512-11′. The program will select a Storage Server 600 having a shorter uptime compared to Storage Server 600, which is subject to path change. The Storage Server 600 having the shortest uptime would be preferred. In step 512-22′-3, the program sends volume mount request to the selected path change target Storage Server 600 so that access to Storage Subsystem 100 can be made via target Storage Server 600. Then in step 512-22′-4, the program sends path change request to Host Computer 200 so that future I/O requests from the Host Computer 200 will be issued to the new target Storage Server 600 rather than the previous source Storage Server 600, which was processing the I/O request before the path change. The program ends at step 512-21′-6.

From the foregoing, it will be apparent that the invention provides methods, apparatuses and programs stored on computer readable media for fast data recovery from storage device failure such as HDD failure. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A system comprising:
a first storage system having a first plurality of storage devices, a first plurality of cache memories, a first plurality of I/O controllers, a first plurality of processors, and a first plurality of disk controllers controlling said first plurality of storage devices; and
a second storage system having a second plurality of storage devices, a second plurality of cache memories, a second plurality of I/O controllers, a second plurality of processors, and a second plurality of disk controller controlling said second plurality of storage devices,
wherein said first storage system stores first status information of said first plurality of storage devices, said first plurality of cache memories, said first plurality of I/O controllers, said first plurality of processors, and said first plurality of disk controllers,
wherein said second storage system stores second status information of said second plurality of storage devices, said second plurality of cache memories, said second plurality of I/O controllers, said second plurality of processors, and said second plurality of disk controllers,
wherein said first storage system sends information of storage failure to a server based on said first status information,
wherein if said first storage system sends information of storage failure to a server, storage availability of the first storage system is calculated based on said first status information using availability rates of said first plurality of storage devices, said first plurality of cache memories, said first plurality of I/O controllers, said first plurality of processors, and said first plurality of disk controllers.

2. The system according to claim 1,
wherein said availability rate is calculated by dividing the number of installed redundant devices against the number of available devices for each component.

3. The system according to claim 2,
wherein said storage availability of the first storage system is determined by the component having the lowest availability rate.

4. The system according to claim 1, further comprising:
a first server receiving said information of storage failures;
a plurality of host computers, which is coupled to said first and second storage systems;
wherein said calculation is send to said first server, and if the calculation results does not meet a threshold, said first server determines whether or not volume migration needs to be performed,
if said first server determines volume migration needs to be performed, volume migration is performed from said first storage system to said second storage system.

5. The system according to claim 4, further comprising:
a plurality of said first storage systems,
wherein said first server receives said information of storage failure from said plurality of first storage systems, calculates storage availability of each of said first storage system based on each of said first status information, and selects storage system subjected to migration among said plurality of first storage system not meeting a predetermined storage availability value, using factors of used years, expected performance, and quality.

6. The system according to claim 4,
wherein when a volume migration is ordered from said first server to said first storage system which sent the information of storage failure, said first server notices the volume migration order to said plurality of host computers,
wherein in response to a first host computer of said plurality of host computers requesting an access data stored in said first storage system, if the request is issued after volume migration order migrating data to said second storage system, said second storage system is accessed from said first computer, and if data is not stored in said second storage system, said second storage system transfers said request to said first storage system.

7. The system according to claim 5,
wherein said first server determines migration target based on storage availability, remaining capacity, and network location, stored in a third memory of said first server.

8. The system according to claim 7,
said first memory includes capacity of each RAID group consisted by first plurality of storage devices.

9. The system according to claim 5,
said first status information includes whether each of said first plurality of storage devices, said first plurality of cache memories, said first plurality of I/O controllers, said first plurality of processors, and said first plurality of disk controllers are operating or not.

10. The system according to claim 5,
said first memory includes whether said RAID group is consisted by internal or external storage devices.

11. The system according to claim 5,
wherein each of said first plurality of processors include a first CPU and a first memory, said first memory stores a first table including said first status information, and
wherein each of said second plurality of processors include a second CPU and a second memory, said second memory stores a second table including said second status information.

12. A method of controlling a system comprising a plurality of storage systems, a plurality of host issuing commands plurality of storage systems:
providing by each said plurality of storage systems status information of components of said plurality of storage systems;
reporting to a system monitoring server from said plurality of storage systems if said components of said plurality of storage systems have defaulted;
calculating storage availability of a first storage system reporting failure among said plurality of storage systems by said system monitoring server, said calculation uses said status information of components of said first storage devices;
determining whether said first storage system requires migration of volumes within said first storage system by said system monitoring server using said calculated results; and
determining target volume among volumes of said plurality of storage systems, notifying volume change to a host computer among plurality of host computers issuing requests to said migrating volumes and issuing mounting request to said target volume, if said system monitoring server decides to migrate said volumes of said first storage system.

13. The method according to claim 12,
wherein said system monitoring server determines to migrate volumes of said first storage system using factors of used years, expected performance, and quality, if said calculated results of storage availability does not meet a predetermined storage availability.

14. The method according to claim 12,
wherein said system monitoring server calculates said storage availability by dividing the number of installed redundant devices against the number of available devices for each component and sets said storage availability of the first storage system as lowest value of divided results.

15. The method according to claim 12,
wherein said plurality of storage system each has a plurality of storage devices, a plurality of cache memories, a plurality of I/O controllers, a plurality of processors, and a plurality of controllers controlling said plurality of storage devices.

16. The method according to claim 14,
wherein said components include a plurality of storage system each has a plurality of storage devices, a plurality of cache memories, a plurality of I/O controllers, a plurality of processors, and a plurality of controllers controlling said plurality of storage devices.

17. The method according to claim 12,
wherein said system monitoring server determines target volume based on said storage availability of said storage systems, remaining capacity, and network location.
